(19) United States
(12) Patent Application Publication
(10) Pub. No.: US 2016/0133060 A1
(43) Pub. Date: May 12, 2016

(54) METHOD AND DEVICE FOR PRODUCING AND OUTPUTTING TOLL TICKETS

(71) Applicant: HENGSTLER GMBH, Aldingen (DE)

(72) Inventors: Dan XU, Rottweil (DE); Rudolf-Michael HORBACH, Emsbueren (DE); Christoph BERNHART, Rottweil (DE); Heinz WEBER, Gosheim (DE)

(21) Appl. No.: 14/896,483

(22) PCT Filed: May 31, 2014
(86) PCT No.: PCT/EP2014/001470

§ 371 Date: Dec. 7, 2015

(30) Foreign Application Priority Data
Jun. 5, 2013 (DE) 10 2013 009 414.3

(51) Int. Cl. G07B 15/00; G06Q 50/30

(52) U.S. Cl. CPC G07B 15/00; G06Q 50/30

(57) ABSTRACT

The invention relates to a method for producing and outputting toll tickets (35) at toll stations, wherein at an output point (1) a single printed toll ticket (35) is presented to the driver of a motor vehicle for removal at at least two output slots (7-10) arranged at a height offset from each other, wherein the toll-relevant data are printed on the toll ticket (35), wherein in a first step a weight class and a size class of the vehicle (6) approaching the output point are first detected by one or more roadway sensors (12, 13), in a second step a controller is activated after the detection and classification of the vehicle (6), which controller decides the vehicle type, and in a third step a printing command for a printer (2-5) for a first lower or upper output slot is produced in dependence on the detection of the vehicle type, and wherein—an additional subsequent vehicle of the same type (for example, a passenger car) is detected—the printing command is simultaneously also produced for a second lower or upper output slot (7, 8; 9, 10) lying after the first output slot (7, 8; 9, 10) in the direction of travel.

The invention relates to a method and device for producing and outputting toll tickets at toll booths in accordance with the summary term of Claim 1.

In prior art, the producing and outputting of toll tickets is characterized in that a toll ticket comprising a magnetic strip is output at a toll booth, wherein the magnetic strip stores the relevant data such as time of arrival, vehicle size, weight class, toll booth location and output time.

The disadvantage of outputting toll tickets with magnetic strips consists of the high cost of such a toll tickets. Furthermore, the printer for producing the toll ticket is relatively complex, since the magnetic strip must be labeled and read with a magnetic reading and writing device. As a further disadvantage, such a toll ticket can be inadvertently deleted by the user, for example if the magnetic strip comes into contact with a magnetic field, e.g. an attachment magnet on the dashboard. This renders the toll ticket unusable.

In addition to high production costs and high equipment expenditures, such toll ticket thus has the added disadvantage of being sensitive to external influences.

It is further known that toll tickets comprising a magnetic strip still have to be imprinted with a price table containing a variety of information, such as vehicle class, weight class, access point, time of access, and more.

When roadway authorities made changes to access points, weight classes or vehicle sizes, the previously imprinted table on the toll ticket became unusable and the tons of paper rolls with pre-printed tables had to be disposed of. Accordingly, another disadvantage of the prior art is not only the attachment of a magnetic strip, but also the use of pre-printed paper rolls, which contain printed information about all fee-related circumstances. When these fee-related circumstances changed, the entire paper supply therefore had to be disposed of.

It is further known that such paper tickets are printed with needle printers, which is associated with high equipment expenditures as well. Needle printers require color ribbons or ink or other print media, which leads to high wear and tear and causes significant consumption costs for printers.

The use of two different output slots at the output point, arranged at different heights, is known from the prior art for producing toll tickets that were printed with needle printers and featured a magnetic strip. The so-called toll booth therefore featured a first output slot on the lower level, wherein the tickets accessible for passenger cars were output in such a way that the driver of a passenger car, approaching at a relatively low height, was able to remove a ticket from the output slot arranged at a lower height.

In contrast, another output slot was arranged at a higher level for truck drivers, from which truck drivers could remove tickets from their elevated position.

When passenger cars and trucks arrived in sequence at an output point, it was known from prior art that a printer (commonly a needle printer) would produce tickets for the lower output slot. If a truck was detected behind a passenger car, the dot matrix printer used for the lower output slot was moved to the elevated position aligned with the upper output slot, using an elevator-type lifting device, in order to produce the ticket at the elevated output slot.

However, this was associated with an undesired time delay, since the dot matrix printer arranged at the lower output slot first had to be brought to its elevated position, aligned with the upper output slot, before it could output a ticket suitable for the upper output slot.

This was associated with a disadvantage in that a relatively long time delay occurred between the output of a ticket in the lower output slot and the output of a ticket in the upper output slot.

Furthermore it was known from prior art that one output level comprised, for example, two side-by-side output slots, wherein the first passenger car driver would remove a ticket from the first output slot and the subsequent passenger car driver would remove a ticket from the output slot lying in the same level, but after the first output slot in the direction of travel.

Accordingly, the sequential output of tickets in sequentially arranged output slots in one plane in the direction of travel was known in the prior art.

However, even such parallel output had the disadvantage that a lifting system had to be assigned to every output slot in order to elevate the dot matrix printer that produced tickets for the lower output slot to the upper position to supply the upper output slot.

Accordingly, an arrangement with a total of four output slots had to use two dot matrix printers with two lifting systems. It is obvious that the production of such tickets processed with magnetic strips and dot matrix printers is particularly complex, expensive, and slow.

The problem solved by the invention therefore is to further develop the method and device for producing and outputting toll tickets at the output points of the type outlined above to allow for a considerably faster ticket output with simpler means.

To solve this problem, the invention is characterized by the technical teaching of Claim 1.

The essential characteristic of the invention is that a first step involves one or more roadway sensors that detect the weight class and size class of a vehicle approaching the output point, that in a second step after detection and classification of the vehicle a controller is activated, wherein the controller decides whether the vehicle type is a passenger car or a truck, and that in a third step a printing command for a printer for a lower output slot is produced in dependence on the detection of the vehicle type, and wherein—if an additional subsequent vehicle of the same type (for example, a passenger car) is detected—the printing command is simultaneously also produced for a second output slot lying after the first output slot in the direction of travel.

An alternative step is characterized in that a printing command for the printer is produced in dependence on the vehicle classification to the upper output slot and characterized in that a printing command is produced to the second upper output slot if a second truck was detected after detecting the first truck.

The expression “produces a printing command for an output slot” is to be interpreted to mean that a printer is assigned to each output slot, with the printer in accordance with the invention having a special design in accordance with the independent device claim.

It is important for the design of the printer in accordance with the independent device claim that it is capable of retrieving blank paper, either from a paper roll or from a folding stack, to print the paper, preferably on both sides. In a preferred embodiment, the front side of the paper is printed with a table and an additional barcode, wherein the barcode contains all toll-relevant data.

For reasons of security and redundancy, the backside of this paper slip is imprinted with the same barcode to guarantee that the same barcode is still readable if the barcode on the front side of the paper slip (toll tickets) is damaged.

This technical teaching offers the advantage that only a blank (non-imprinted) paper is used as the template for a toll ticket, and that a table with toll-relevant data and at least one bar code is only printed on the front side of the paper slip when an approaching vehicle is detected.

This has the advantage that it is no longer necessary to use pre-printed paper rolls or paper stacks with pre-printed tables of toll-relevant data. In this manner, if the roadway authority changes one or more toll-relevant data, this is simply communicated to the printer with a printing command, and an amended table is printed on the current toll ticket.

This eliminates the complex, expensive and sensitive magnetic strip, and updates to the table with regard to toll data can be performed during the operation, making it superfluous to interrupt the operation to print new tickets because a change to the table was entered into the printer during operation as an amended printing command.

There is thus the advantage of a very fast production of toll tickets to an output point because the system according to the invention assigns a separate printer to each output slot, which is capable of double-sided printing on a blank paper slip.

This eliminates the complex lifting equipment required for the prior art and the printers imprinting both sides of a blank paper slip are particularly fast, which guarantees the speedy output of toll tickets at the output point.

Accordingly, the production of toll tickets is also considerably more economical because the preferred paper is a thermal printing paper, which is not associated with any consumption costs such as color, ink, ink ribbons or the like. The thermal paper is imprinted and dyed exclusively by the print head of the printer, which causes no further consumption costs.

It is important for the thermal paper to have dual-side coating (thermoactive), which means that it can be separately imprinted on the front and backside and that the imprint on one side does not bleed through to the imprint on the other side.

This creates the essential advantage of paper savings, since no expensive paper needs to be purchased, which has to be discarded with every change.

Another savings comes from the elimination of the magnetic strip as well as the reduction of freight, logistical and storage costs, because only one variety is used for all toll booths.

The subject of the present invention not only results from the subject of the individual patent claims, but also from the combination of the individual patent claims.

All information and features disclosed in the documents, including in the summary, especially the spatial arrangement shown in the drawings, are claimed as essential to the invention, provided they are novel compared to the prior art, either individually or in combination.

The following section explains the invention in greater detail, using drawings that represent only one embodiment. The drawings and their description disclose further features and advantages of the invention.

The illustrations show the following:

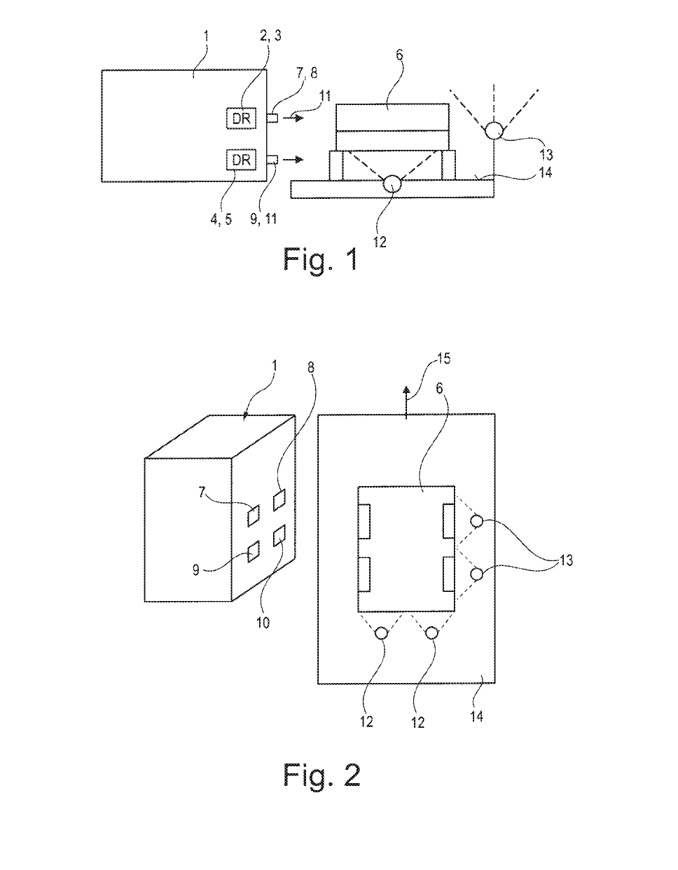

FIG. 1: View of an output point from the front

FIG. 2: Top view of output point according to FIG. 1, with building view partly shown in perspective

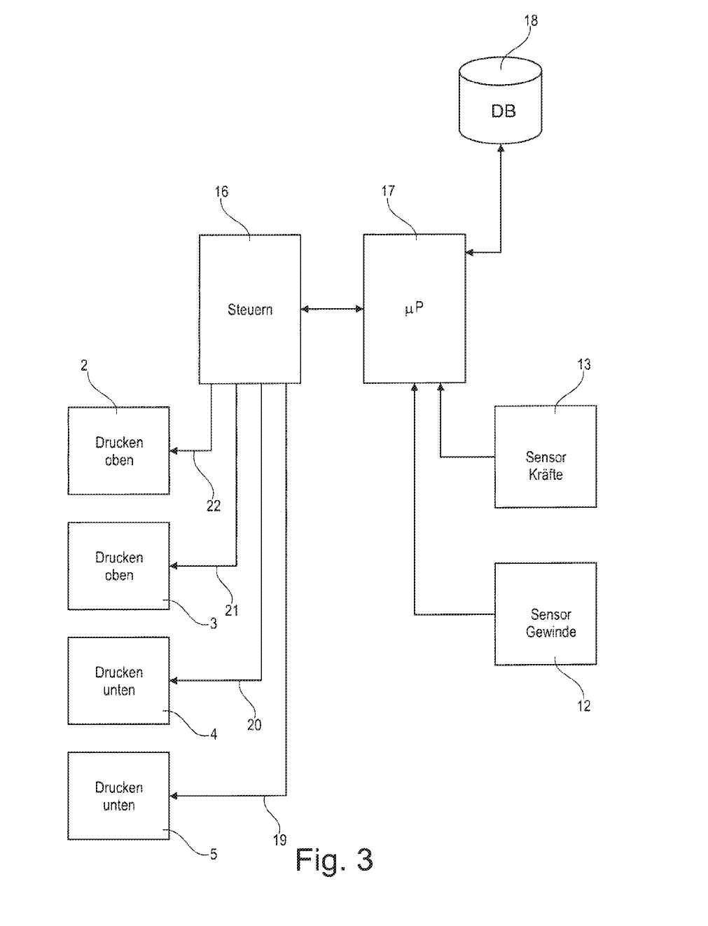

FIG. 3: Schematic circuit diagram for producing the printing commands for a total of four different printers

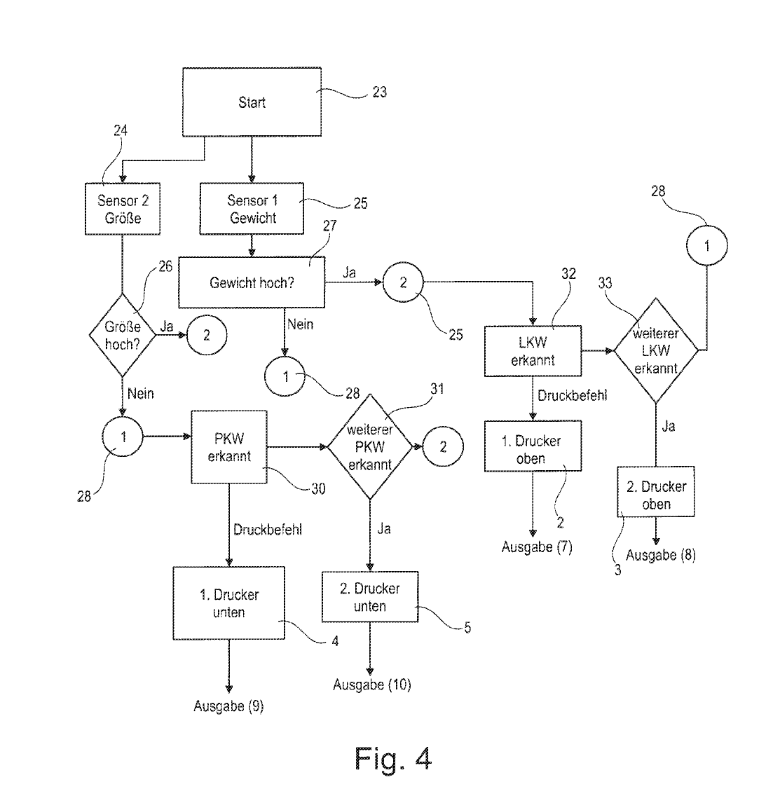

FIG. 4: Decision diagram for generating the printing commands

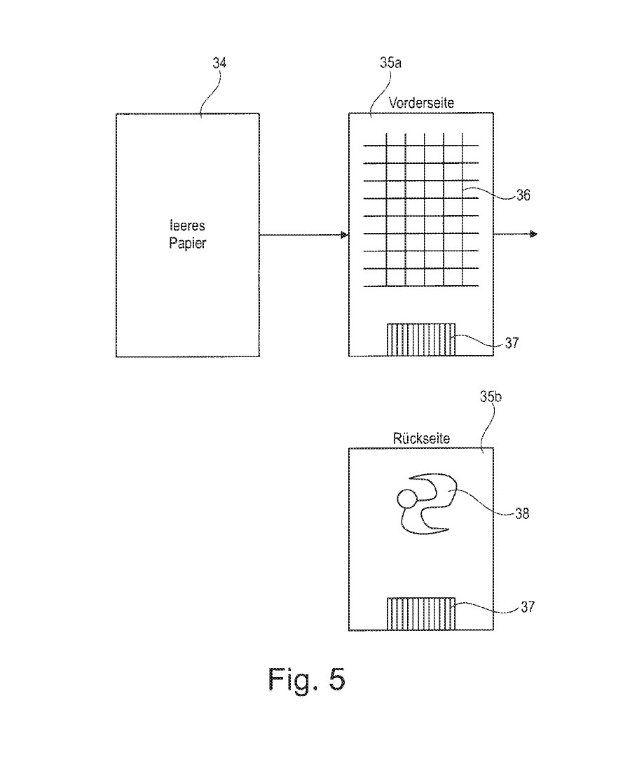

FIG. 5: Top view and rear view of a toll ticket during printing

It is assumed for FIGS. 1 and 2 that a vehicle 6 moving on roadway 14 approaches an output point 1, in which at least two output slots 7, 8 or 9, 10 are arranged lying behind each other in the direction of travel.

Each output slot 7-10 has an assigned individual printer 2-5, which preferably imprints a blank paper slip on both sides.

Provided the roadway sensors 12, 13 detect the weight (sensor 12) and the size (sensor 13) of vehicle 6, the vehicle is classified in a computer system in conjunction with a database. It is then determined on the basis of the detected classification whether the vehicle is a passenger car or a truck.

Accordingly, one printer 4, 5 is activated to produce a toll ticket 35 for the lower output slot 9 or 10.

If, for example, two passenger cars are approaching the output point 1 in sequence, the second vehicle is detected by the sensor setup 12, 13 and it is determined that two passenger cars are approaching the output point 1, wherein the first printer 4 for the output slot 9 is activated for output slot 9 and the driver of the first passenger car can immediately retrieve the ticket from output slot 9.

Since the second approaching vehicle was detected as a passenger car as well, printer 5 is also activated for the output slot 10 lying behind it. As soon as the first passenger car has left the output point, the driver of the second passenger car is immediately presented with the toll ticket 35 in the second output slot 10 (below) of the same retrieval level.

The same procedure also applies to the detection of vehicles 6 that were classified as trucks, to which the ticket is produced via an elevated output slot 7, 8. Again, the ticket is presented to the driver in the direction of arrow 11, and the driver can very quickly remove the ticket from the corresponding output slot 7-10 without any further actions.

FIG. 3 shows an exemplary control system to activate four different printers 3-5. Depending on the data in a database 18, a microprocessor 17 interacts with sensors 12, 13 to detect the vehicle size and weight.

The classification of the detected vehicle takes place in microprocessor 17 in conjunction with a database query. Accordingly, control 16 is activated, which then activates a printer 2-5 depending on the detected classification and the current vehicle position (front or rear vehicle).

Accordingly, only a single connection 19, 20, 21, 22 produces a printing command at a specific point in time to ensure that only one printer produces and outputs a toll ticket 35.

If the driver of vehicle 6 refuses to accept the toll ticket 35 in the output slot 7-10, the ticket provided by a presenter in the output slot 7-10 will be withdrawn and discarded in the printer by making it invalid.

FIG. 4 shows an exemplary decision tree for activating the four different printers 2-5. Position 23 marks the start of the decision tree, wherein positions 24 and 25 query sensors 12 and 13 to detect the size of the vehicle in position 26 and the weight of the vehicle in position 27. Depending on the contour size and detected weight, the system branches off to decision point 28 for smaller passenger cars or to decision point 29 for taller vehicles.

If a vehicle with a low weight and/or small size was detected, position 30 decides that a passenger car was detected and a printing command is produced to the first lower printer 4, where the output slot then presents toll ticket 35.

If the sensors detected a second passenger car after the first passenger car, position 31 signals the detection of the second passenger car and another printing command is produced to the lower printer 5, causing the presentation of the toll ticket at the lower output slot 10.

In contrast, if decision point 29 detects a tall vehicle with the corresponding size or large weight, position 32 determines that the vehicle must be a truck and a printing command is produced for the first printer on the top, for example printer 2, which then presents the toll ticket 35 in the output slot.

If a second truck is detected in position 33 after the first truck in position 32, another printing command is produced to the second printer 3 (above), and a toll ticket 35 is presented at the second upper output slot 8.

FIG. 5 shows an example of a paper slip 34, blank on both sides, being taken from a roll or a folding stack, with both the front side 35a and the backside 35b imprinted in the same printing process.

Printer 5 preferably imprints the front side 35a with the current table 36, in which the toll-relevant data are presented in human-readable form, while the printer at the same time imprints a barcode 37 on the front side 35a, which contains the toll-relevant data in digital form.

For safety reasons, the same barcode 37 is also imprinted on the backside 35b of the toll ticket 35. The backside can additionally be used to imprint advertising 38 or the like.

The advantage of the method according to the invention accordingly is a significant acceleration in that the production and output of toll tickets to an output point because the complex lifting devices for printers are eliminated and a separate printer 2-5 is assigned to each output slot 7-10 and in that the two-sided printing of blank paper slips does not generate consumables if thermal paper that is coated and printable on both sides is used.

### DRAWING LEGEND

1 Output point
2 Top printer
3 Top printer
4 Bottom printer
5 Bottom printer
6 Vehicle
7 Top output slot
8 Top output slot
9 Bottom output slot
10 Bottom output slot
11 Direction of arrow
12 Sensor (weight)
13 Sensor (size)
14 Roadway
15 Direction of travel
16 Control
17 Microprocessor
18 Database
19 Connection
20 Connection
21 Connection
22 Connection
23 Position
24 Position
25 Position
26 Position
27 Position
28 Decision point
29 Decision point
30 Position
31 Position
32 Position
33 Position
34 Paper slip
35 Toll ticket 35a 35b
36 Table
37 Barcode
38 Advertisement

1. A method for producing and outputting toll tickets (35) at toll stations, wherein at an Output point (1) a single printed toll ticket (35) is presented to the driver of a motor vehicle for removal from at least four Output slots (7-10) wherein at least two are arranged at a height offset from each other, wherein toll-relevant data is printed on the single printed toll ticket (35), comprising:
in a first step, first detecting a weight class and a size class of the vehicle (6) approaching the Output point by one or more roadway sensors (12, 13),
in a second step activating a Controller after the detection and Classification of the vehicle (6), wherein said Controller detects a vehicle type, and
in a third step producing a printing command for a printer (2-5) for a first lower or upper Output slot in dependence on the detection of the vehicle type, and
wherein, if an additional subsequent vehicle of the same type is detected, simultaneously also producing the printing command for a second lower or upper Output slot (7, 8; 9, 10) lying after the first Output slot (7, 8; 9, 10) in a direction of travel.

2. The method according to claim 1, wherein a printing command for a printer (2, 3) is produced in dependence on the vehicle classification to the upper Output slot (7, 8) and further comprising producing a printing command to the second upper Output slot (7, 8) if a second truck was detected after detecting a first truck.

3. The method according to claim 1, further comprising using only a blank (unprinted) paper slip (34) as a template for the toll ticket as a template for a toll ticket (35, 35a, 35b) and printing a table with the toll-relevant data and at least one barcode on a front of a paper slip (34) during detection of an approaching vehicle.

4. The method according to claim 1, wherein a separate printer (2-5) is allocated to each Output slot (7-10), which is capable of double-sided printing on a blank paper slip (34).

5. The method according to claim 3, wherein a thermal paper that is printable on both sides is used as the paper slip (34).

6. A device for producing and outputting toll tickets (35) at toll stations, wherein an Output point (1) comprises at least four Output slots (7-10), wherein at least two are arranged at a height offset from each other, wherein one or more roadway sensors (12, 13) are arranged for the detection of a weight class and a size class of two vehicles (6) approaching the Output point (1), comprising:
a Microprocessor (17) configured and operable to detect and classify the vehicle (6) to determine vehicle type, and
a Controller (16) configured and operable to
produce, in dependence on the vehicle type, a printing command for a printer (2-5) for a first, lower or upper Output slot (7, 8, 9, 10),
output a printed toll ticket (35), whereupon the toll-relevant data are printed, and,
if the roadway sensors (12, 13) detect another subsequent vehicle of the same type, output a simultaneous printing command to a printer (2-5) for a second lower or upper Output slot (7, 8, 9, 10) lying after the first Output slot (7, 8; 9, 10) in a direction of travel.

7. The device according to claim 6, wherein each Output slot (7-10) has its own assigned printer (2-5), which is designed for double-sided printing on a blank paper slip (34).

8. The device according to claim 6, wherein the paper section (34) is a thermal paper that is printable on both sides.

9. The method according to claim 1, wherein the type of vehicle is a passenger car.

10. The method according to claim 6, wherein the type of vehicle is a passenger car.
